(19) United States
(12) Patent Application Publication
(10) Pub. No.: US 2010/0255281 A1
(43) Pub. Date: Oct. 7, 2010

(54) POLYMERIC ARTICLES HAVING ANTIMICROBIAL PROPERTIES CONTAINING NANO SILVER PARTICLES

(76) Inventors: Shad M. Cockman, Brown Summit, NC (US); Antonio Lombardi, Oak Ridge, NC (US); Jayson C. Linard, Alparetta, GA (US); Mack D. Jones, Jamestown, NC (US)

Correspondence Address: PASSE' INTELLECTUAL PROPERTY, LLC, 1717 BRASSFIELD RD., RALEIGH, NC, 27614, US

(21) Appl. No.: 12/721,069

(22) Filed: Mar. 10, 2010

Related U.S. Application Data
(63) Continuation of application No. 61/167,317, filed on Apr. 7, 2009.

(51) Int. Cl. B32B 5/16; C08K 3/08

(52) U.S. Cl. 428/220; 428/328; 523/122; 977/773; 977/762

(57) ABSTRACT

The present invention relates to the use of nano silver particles in a polymeric article which provides antimicrobial properties to the article. Since it has been discovered that nano silver is much more effective than colloidal silver ions, much less silver and thus, decreased cost can be achieved using the nano silver particles of the present invention.

This application claims priority of U.S. provisional application No. 61/167,317 filed on Apr. 7, 2009 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to polymers having antimicrobial properties comprising nano silver particles in the polymer and the process for producing the antimicrobial polymers.

2. Description of Related Art

The antimicrobial properties of metallic ions and their colloidal forms are known. Silver and other ions have been used extensively as a disinfectant and germicide, for example, in the form of silver nitrate. Colloidal silver exists up to almost 1000 nanometers in size. However, it is inconvenient to use solutions for materials and such products usually have handling restrictions. In addition, their cost has been prohibitive in many cases. Polymers containing compositions for holding metallic colloidal ions have also been utilized, but free ionic forms with carrier molecules have not been very successful and have their own share of problems.

One form of carrier molecules with metallic ions that initially showed promise but has turned out to be not that successful is the use of large (colloidal) metallic ions held by zeolite particles. In U.S. Pat. No. 4,775,585 issued Oct. 4, 1988 to Hagiwara et al. there is disclosed metallic zeolites in polymers for their antibacteriocidal effect. However, even using colloidal silver ions which have an effective dose lower than other metallic ions such as zinc and copper, the extra weight of these materials and compatibility are an issue in producing an acceptable commercial product. In addition, the product articles seem to be limited to small thicknesses such as fibers, films or granules with thicker polymeric articles simply not working. It is also noted that the inventors of the zeolite additives state that too much or too little zeolites has an overall detrimental effect on the product.

Nano silver are particles made up of many atoms of silver in non-ionic form. The particles are on the nano size scale of 1 nano meter to about 100 nano meters. Nano particles have been used by completely dispersing particles of about 25 nm in size in polymeric films of from about 0.02 to 0.15 mm in thickness. These have been described as having food preservative benefits. Primarily they benefit from using nanosilver attached to the stalk marrow of Juncus effusus L.

Accordingly, use of metals, even silver, as antibiotic groups especially in plastics has been of limited value in producing antimicrobial products. This is especially true when considering cost of metals and the difficulty in incorporating enough metal into a product. There is a need in the industry to avoid the problems of large ionic metals on plastics, yet, still provide a lightweight durable material.

### BRIEF SUMMARY OF THE INVENTION

The present invention relates to the discovery that dispersing or admixing nano silver particles into a polymer or polymeric mixture allows for the production of rigid or semi-rigid antimicrobial plastics of virtually any size, shape or thickness (other than film) without the problems of the prior art. In addition, with use of nano sized silver particles verses, for example, macro ionic silver, or colloidal silver, it has been discovered that less silver can be utilized, thus, decreasing the weight of silver containing rigid or semi-rigid plastics, decreasing the cost of silver added to plastics and decreasing the ionic and other interactions between silver (and other additives such as carrier molecules) and the plastics themselves while producing an improved antimicrobial product.

Accordingly, in one embodiment of the invention there is disclosed a polymeric article having antimicrobial properties in which the polymer article comprises one or more polymers and nano silver particles having a size of between about 1 and 100 nanometers and particles comprising from about 0.001% to about 0.5% of at least the surface of the polymeric article.

In yet another embodiment, the invention relates to a process for the production of an antimicrobial polymeric article comprising one or more polymers comprising:
a) admixing into at least the surface of the polymer from about 0.0001% to about 0.5% of nano silver particles having a size of between about 1.0 and 100 nanometers in at least the surface of the polymeric article; and
b) molding the polymer with dispersed nano silver into a desired shaped article.

### BRIEF DESCRIPTION OF THE DRAWINGS

FIG. 1 is a front view of a rigid polymeric article having nano silver in a portion of the article.

FIG. 2 is a front view of a semi-rigid light plate with the side facing the viewer having nano silver in the surface of the plate.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “article” refers to rigid or semi rigid articles for use in manufacturing objects. Excluded from the scope of the invention are thin highly flexible films designed for use, for example, in food bags and the like. Rigid articles like thick blocks or objects made of semi-rigid polymer are contemplated and semi-rigid articles which are thicker than about 0.05 to 1 mm. In one embodiment, the article is at least 1 millimeter thick. In other embodiments, the article can be 2, 3, 4, 5, 6, 7, 8, 9, 10, 15, 20, 30, 35, 40, 50 or more millimeters thick.

Large blocks can be of any thickness, greater than film thickness, and exhibiting rigid or semi-rigid properties (as opposed to flexible films). Films are generally in the 0.02 to 0.15 mm thickness and not within the scope of the present invention.

As used herein a “polymeric article” refers to articles as described above of synthetic and semi-synthetic carbon based polymers and is not limited to any particular polymer. Included in the suitable polymers are thermoplastic polymers such as polyethylene, polypropylene, polystyrene, polyvinyl chloride, polyvinylidene chloride, polyamides, polyesters, polyvinyl alcohol, polycarbonates, polyacetals, ABS resins, acrylic resins, fluorine-contained resins, polyurethane elastomers, polyester elastomers; thermosetting synthetic polymers such as phenolic resins, urea resins and urethane resins; regenerated or semi-synthetic polymers such as rayon, cuprammonium rayon, acetate rayon, triacetate rayon.

Other polymers include Nylon 6, Nylon 66, polyethylene terephthalate, polybutylene terephthalate, polyacrylonitrile, polyethylene, polypropylene and copolymers thereof; regenerated or semi-synthetic polymers such as rayon, cuprammonium rayon, acetate rayon and triacetate rayon.

In this invention “nano silver” refers to the non-ionic, non-colloidal form of silver in nano particle size, for example, as obtainable in pure de-ionized water with sliver (Ag) in suspension. Approximately 80% of the sliver is in the form of silver nano particles less than two nano meters in diameter and as small as 1 nm in diameter and as large as 100 nm. In one embodiment the particles are from about 1 nm to about 20 nm in size. Though similar to colloidal silver, colloidal silver is a suspension of particles up to a full micron in diameter. The performance characteristics in the present invention, however, are entirely different products. Since it is difficult, if not next to impossible, to have a 100% nano particle silver, it is assumed that it is likely at least a portion of the silver can contain the silver ions in addition to the nano silver. In fact, one could add in addition to the nano particles, other silver or metallic ions as desired. However, ultra centrifuges can continue to refine a silver solution (or other source of non-ionic silver nano particles) into higher percentages of nano particle silver. Nano particles can be comprised of entirely one type of nano silver or be comprised of multiple silvers either in layers or as a mixture.

The particle size of the nano silver used in the present invention is from about 1 to about 100 nanometers in diameter. In one embodiment, they are in the range of about 1 to 20 nanometers in size. The exact range of particle size will depend on the source of the nano particles, the method used to separate them, the method of manufacture and the particular polymer or polymers used in the fabrication of an individual article. In general, the size that is smaller will require less silver by weight and thus, decrease the weight of the final production polymeric product not to mention reduce the overall cost of any product compared to use of silver ions alone. It is understood that because of the nature of nano silver there may be some silver ions present in the product, however, the benefit of this invention is due to the presence of the nano silver particles. In some embodiments, the article can utilize other antimicrobial metals or other antimicrobials in combination with the nano silver. Other metals such as Copper or Zinc could be used in one embodiment. The articles of the present invention being rigid or semi-rigid in nature are designed to be handled either during installation or use and thus, must have certain characteristics not possessed by film plastics.

While the key to the present invention is the type of silver, the size of the silver particles in the nano range and in the thickness of the polymeric article which gives the products the increased efficacy, it is certainly possible that a carrier molecule can be used to deliver the silver nano particles as long as one is delivering the nano silver particles as described herein. Such carriers are well known so even the zeolites could be used with silver nano particles if fashioned to retain the nano silver particles. Another carrier of the present invention would be nano tubes and in one embodiment water soluble nanotubes. One skilled in the art could select other carrier molecules for nano silver without undue experimentation.

The objects utilizing nano silver particles themselves can be relatively thin (semi-rigid) shapes or they can be larger more rigid shapes as well. Large shapes include rods, blocks and the like and can also include shaped plastic parts designed to have individuals touch them on at least a portion of their surface. One example of a semi rigid article is the light switch plate in the figures whose front surface will be frequently touched as will the switch itself. The surface of the place and the switch can include the silver of the present invention, so virtually any shape can be included in the invention.

The product of the present invention is made by means of admixing the nano silver particles (with or without a carrier) into the polymer. The admixing can be into the surface of the polymer or into an entire article made from the polymer. The precise method is not otherwise restricted and numerous methods may be used to disperse the nano silver particles into a given polymer. The best method will depend on the particular polymer chosen and its particular properties, how the polymer is to be molded or shaped and under what temperature and pressure this is accomplished. One skilled in the art can balance these parameters to obtain an optimum performance in admixing and final product. The use of carrier molecules can aid in even distribution of the nano silver particles since less silver is necessary for the desired effect but not critical for the practice of the present invention unless distribution is an issue with an individual polymer or product made with the nano silver. The formation and cooling of a polymeric article can be done by conventional means. In addition, the polymer can start out as a monomer and have the nano silver particles added and the polymer subjected to polymerization. The article can then be subjected to molding. The best process will be chosen depending on the nature of the polymer or polymers selected, the size and shape of the article and the particular use of the article containing the silver nano particles.

In forming an article of the invention that is itself to be later molded, carved or otherwise shaped into a separate product for sale, the polymer can be formed into blocks, slabs or other large shapes while other smaller sizes like rods, sheets and the like can also be formed. Since the effect of the nano silver particles is basically a surface effect, the nano sliver particles in one embodiment can be admixed such that it is essentially only incorporated into the surface of the product. In one more embodiment, the surface incorporating the nano silver is only present in the area where someone would come into contact with the article and thus, worry about achieving a bactericidal effect. Since silver is relatively expensive, the prior art zeolite particles with silver ions are extremely expensive to use in addition to the extra weight caused by the relative higher density of metallic silver ions. The manufacture of products with non-nano metallic ions or colloids alone cannot be over emphasized as fraught with problems when considering using them in commercial products and their minimization is desirous.

The polymer in the present invention can contain components other than just the silver nano particles. For example, polymerization catalysts, stabilizers, delustering agents, optical whitening agents, pigments, fillers, plasticizers and the like, can be added to the polymer. The final molded article may also contain liquid or other organic solvents. The nano silver can be added or suspended in such liquids or the liquid mixed into the polymer with any other additives desired.

An article comprising a polymer and the silver nano particles can be combined or mixed with other articles such that only a portion of a final article is composed of the nano silver containing polymer article. Where a particular article has or comprises numerous parts and just some of the parts are subject to being touched, one could make just the parts that come in human contact with the polymer of the present invention. In one embodiment, once again only the surface of the part needs to contain the silver nano particles.

The present invention is an improvement over the prior silver ion and colloidal silver containing plastics. The nano silver particles distribute more evenly, are more effective and thus, require less silver and therefore cheaper to use than just using silver ions or colloidal silver. Because of the size and reduced quantity of silver, the durability and molding properties are improved over the colloid/ion type products.

In one embodiment of the present invention, the polymeric article is treated such that at least a portion of the surface of the article is coated with or contains a thermochromic material. Preferably, the thermochromic material is placed in the same location as the antimicrobial nano silver particles. The thermochromic material would be chosen to react to the temperature of a hand or other body part such that when a polymeric article is handled or otherwise touched, there is evidence of it having been recently handled. It could also be used as an indentifying material in order to let people know the material contains an antimicrobial. Over a brief period of time the thermochromic material would return to its ambient temperature color. One seeing the recent handling of an item would know that there is possibly the chance that the nano silver particles have not had enough time to have its antimicrobial effect, while not seeing handling evidence would increase the likelihood that the item has had the appropriate time to pass to have an antimicrobial effect by the nano silver particles.

Thermochromic materials or pigments for inclusion in plastics or coating of plastics are well known in the art and can be chosen for their compatibility with the polymer selected as well as compatibility with nano silver particles. Thermochromic materials are materials which change their observable color based on their particular temperature. The precise thermochromic material should be chosen to show a color change based on the temperature of skin when the article is touched and another color at ambient temperatures other than skin temperature. The change typically happens over a few seconds to several minutes or more depending on the particular thermochromic material selected. The thermochromic materials can be either incorporated into the plastic with the nano silver particles or applied as a coating to all or a portion of an article containing the nano silver particles of the present invention. It should be noted herein that these materials could be used in a likewise manner with any antimicrobially treated article. The crystalline thermochromic materials are very precise in temperature control but have limited colors available. The thermochromic dyes, and the like, offer a wider variety of colors, but are not as precise in temperature however, they are sufficient for most needs in the present invention. They are typically colorless at one temperature and can be made to turn a particular color at a different temperature.

The use of thermochromic dyes, pigments and the like can be by the methods known in the art, for example, mixing into the polymer with the nano silver particles or applying the thermochromic material to the surface of a portion of the polymer in liquid form for spraying or other topical application. One skilled in the art of thermochromic materials could easily apply, treat or include the thermochromic materials into the products of the present invention.

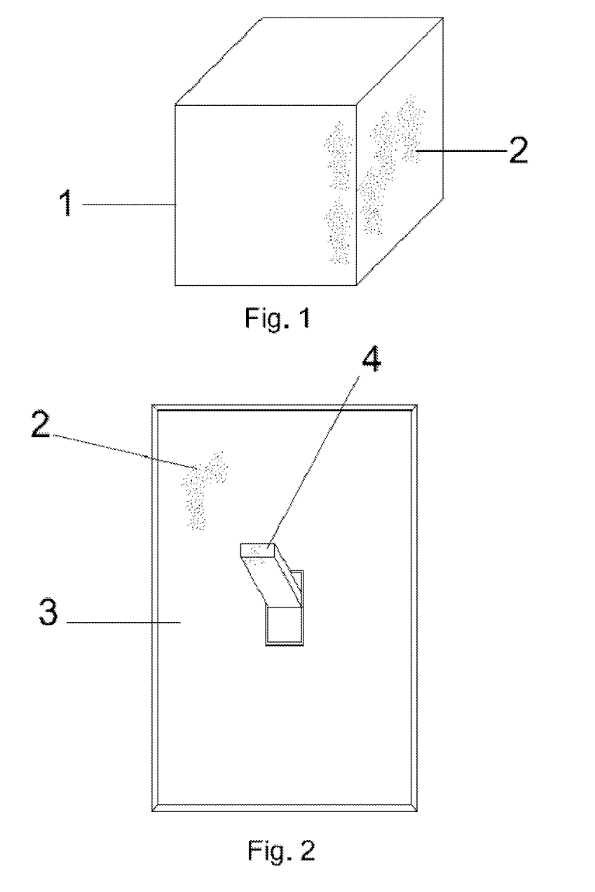

Now referring to the drawings, FIG. 1 is a perspective view of a block polymer 1 with silver nano particles 2 distributed in one face of the article. The size of the nano particles 2 are exaggerated for the purpose of demonstration. FIG. 2 depicts a light switch plate 3 and light switch 4. In this view only the surface of the front of the light switch plate 3 has the silver particles since the reverse side is essentially not in contact with humans except perhaps during installation. The switch 4 itself being small, could be entirely distributed with silver particles 2.

The drawings are not intended to be limiting nor intended to be inclusive of all examples. Other methods of making article sources of nano sized silver particles and the like are possible within the skill in the art. What is clear is that utilization of nano silver particles versus the colloidal particles provides a clear advantage to the user. The claims which follow should not otherwise be read as limiting the invention.

What is claimed is:

1. A polymeric article having antimicrobial properties in which the polymer article comprises one or more polymers and nano silver particles having a size of between about 1 and 100 nanometers.

2. A polymeric article according to claim 1 wherein the particles comprise from about 0.0001% to about 0.5% of at least the surface of the polymeric article.

3. A polymeric article according to claim 1 wherein the silver particles are from about 1 to about 20 nanometers in size.

4. A polymeric article according to claim 1 wherein the article has nano silver particles dispersed in the surface of the polymeric article.

5. A polymeric article according to claim 1 wherein the article has nano silver particles dispersed throughout essentially the entire article.

6. A polymeric article according to claim 1 which has a minimum thickness of at least 0.05 mm.

7. A polymeric article according to claim 1 having a thickness of from at least about 1 millimeter.

8. A polymeric article according to claim 3 wherein the portion of the article surface containing the nano silver particles is confined to the surface designed to come in contact with a user of the article during use of the article.

9. A polymeric article according to claim 1 wherein the nano silver is held by a carrier molecule.

10. A polymeric article according to claim 9 wherein the carrier is a zeolite.

11. A polymeric article according to claim 9 wherein the carrier is a nanotube.

12. A polymeric article according to claim 9 wherein the nanotubes is a soluble nanotube.

13. A polymeric article according to claim 1 wherein there is no carrier associated with the nanosilver particle.

14. A polymeric article according to claim 1 which further comprises thermochromic material for reacting to contact by an individual handling the polymer.

15. A process for the production of an antimicrobial polymeric article comprising one or more polymers comprising:
a) admixing in at least the surface of the polymer form from about 0.001% to about 0.5% of nano silver particles having a size of between about 1 and 100 nanometers in at least the surface of the polymeric article;
b) molding the polymer with dispersed nano silver into a desired shaped article.

16. A method according to claim 15 wherein the nano silver particles are held by a carrier molecule.

17. A method according to claim 16 wherein the carrier molecule is a zeolite.

18. A method according to claim 16 wherein the carrier molecule is a nanotubes.

19. A method according to claim 15 wherein the particle size is from about 1 to about 20 nanometers.

20. A method according to claim 15 wherein the article has a minimum thickness of about 0.05 mm.

21. A process according to claim 15 wherein there are no carrier molecules.

22. A process according to claim 15 wherein the polymeric article further comprises a thermochromic material for reacting to contact by an individual handling the polymer.

23. A polymeric article having antimicrobial properties in which the polymer article comprises one or more polymers, an anti microbial agent and a thermochromic material for reacting to contact by an individual handling the polymer.
